(19) United States
(12) Patent Application Publication
(10) Pub. No.: US 2011/0293082 A1
(43) Pub. Date: Dec. 1, 2011

(54) Method for Enabling and Blocking Distance and Location Information Between Callers

(76) Inventor: Rajinder Gauri, Greenwich, CT (US)

(21) Appl. No.: 13/150,324

(22) Filed: Jun. 1, 2011

Related U.S. Application Data
(60) Provisional application No. 61/350,345, filed on Jun. 1, 2010.

(51) Int. Cl. H04M 1/00

(52) U.S. Cl. 379/142.02

(57) ABSTRACT

A method and system are disclosed for enabling and blocking distance and location information between callers. The method includes a subscribing caller's phone identifying the caller by name and location and initiating a request to locate (RTL) signal to a called party's phone. The called party in turn sends an enable to locate (ETL) signal back to the called party to initiate calculations for determining the called party's distance from the caller. The method also includes an ETL bypass for business relations where an employer has a need to locate the employee. The method may also include a blacklisting feature allowing the called party to block RTL from undesired parties. A disclosed computer program product triangulates the distance between callers using the transmission time between them and stationary transmitters, landline relays, and/or internet routers. An alternate embodiment may include trilateration data from GPS satellites in determining the distance between callers.

### CROSS-REFERENCE TO RELATED APPLICATION

This application claims the benefit of the priority date of earlier filed U.S. Provisional Patent Application Ser. No. 61/350,345, filed Jun. 1, 2010 for Rajinder Gauri titled, Method for Enabling and Blocking Distance and Location Information Between Callers, incorporated herein by reference in its entirety.

### BACKGROUND OF THE INVENTION

Caller ID is a telephone service that transmits a caller's telephone number and name to the called party's telephone during the ringing signal before the call is answered. The caller's name and number are most commonly displayed on the called party's telephone enabling the called party to screen calls from telemarketers and other unwanted calls. However, it may also allow the called party to be evasive and hard to locate.

Caller ID works on the concept of informed consent but also poses issues for personal privacy. Generally, unlisted numbers are blocked. Non-published and regular listed numbers are not usually blocked. If desired, callers need to take steps to ensure that their number will not be displayed. In some locations in the United States, regulators allow (or require) blocking to be automatic, transparent to the caller.

Where blocking is applied at the time a call is made, callers can block their numbers from being displayed by dialing a special code before making their call. However, their number may still be transmitted through the entire telephone network, with the destination phone expected to honor the blocking request.

Similarly, a feature known as anonymous caller rejection rejects all calls when the caller's number is blocked. In other instances, anonymous calls are routed to a service, where the caller is required to announce him or herself. The service then asks the called party if they want to accept or reject the call.

### SUMMARY OF THE INVENTION

A method is disclosed for enabling and blocking distance and location information between callers. The method includes a caller's phone initiating a request to locate (RTL) signal to a called party's phone. The called party's phone may display the caller's identification by name and by the caller's location depending on whether the called party is subscribed to a ‘LocID’ (location identification) service and the caller does not block the disclosure of his or her location. The called party's phone may also display a message indicating the RTL request with the caller's name and/or number. At the called party's discretion, the called party's phone returns an enable to locate (ETL) signal to the caller's phone to initiate the calculations necessary for determining the called party's location and the distance between the caller and the called party.

The disclosed method also includes an ETL bypass or override for employee and employer relations where an employer has a business need to locate the employee without the employee necessarily granting permission. The method also includes a blacklisting feature which allows a called party to block an RTL coming from numbers and/or names of undesired parties.

Embodiments of the disclosure also include a computer program product comprising a computer readable medium having computer useable program code. The program code is executable to perform operations for enabling and blocking distance and location information between wireless callers. The operations of the computer program product include triangulating the location and distance from the caller to a called party using the transmission time between the callers and multiple stationary wireless transmitters, landline relays and/or internet routers. A database of predetermined distances from each subscriber's landline connection to possible landline relays and/or internet routers may also be stored in a subscription provider's database for transmission in part or in whole during the disclosed handshaking protocol. An alternate embodiment may include trilateration data from GPS satellites to determine the distance between the caller and the called party given location information for the callers.

Other aspects and advantages of embodiments of the disclosure will become apparent from the following detailed description, taken in conjunction

with the accompanying drawings, illustrated by way of example of the principles of the disclosure.

### BRIEF DESCRIPTION OF THE DRAWINGS

FIG. 1 is a flow chart of a method for enabling and blocking distance and location information between callers via a network in accordance with an embodiment of the present disclosure.

FIG. 2 depicts electronic transactions of a method for enabling and blocking distance and location information between two or more callers in accordance with an embodiment of the present disclosure.

FIG. 3 is a flow chart of an embodiment of a method for enabling and blocking distance and location information between callers via a network in accordance with the present disclosure.

FIG. 4 depicts a wireless phone display for a calling party and a called party in accordance with an embodiment of the present disclosure.

FIG. 5 is a flow chart of a method for blocking distance and location information between callers in accordance with an embodiment of the present disclosure.

FIG. 6 is a flow chart of a method for calculating an estimated time of arrival of a called party at a third party location in accordance with an embodiment of the present disclosure.

FIG. 7 is a depiction of an electronic display of called parties and third parties in relation to estimated time of arrival of furniture deliveries in accordance with an embodiment of the present disclosure.

FIG. 8 is a flow chart of a computer program product for enabling and blocking distance and location information between callers in accordance with an embodiment of the present disclosure.

FIG. 9 is a flow chart of a communications protocol for blocking distance and location information between callers in accordance with an embodiment of the present disclosure.

Throughout the description, similar reference numbers used in one figure may be used to identify similar elements in other figures.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the claims.

Throughout the present disclosure, the term ‘calling party’ may comprise a single or multiple callers or users of a communications device. A communications device may comprise a landline telephone, a cellphone or smartphone, a computer connected to a digital phone such as Voice Over Internet Protocol (VOIP) any type of electronic electromagnetic communication device through voice, text, pictures, etc. The term ‘called party’ is similarly used throughout the disclosure. The term ‘network’ may comprise one of a voice, a data, an internet, a wireless and a satellite technology and any combination thereof such as VOIP phone.

In many instances, it is desirable and even necessary to know the location of a calling party and distance between two or more callers. One particularly advantageous application of the present disclosure is for predicting the time of arrival of delivered vendor products. It is common for multiple furniture deliveries to be loaded onto a single large truck assigned to cover a large metropolitan area. Customers waiting for their furniture delivery on one side of the city may be required to take several hours off work to be present for the truck to arrive after first completing deliveries from another side of the city. Also, routes may need to be changed because of road construction, lunch detours or a missing customer. Therefore, it is desirable to be able to locate a delivery truck and to update arrival times for subsequent deliveries not only for the customer's sake but also for efficient use of business resources.

On the other hand, it is not always desirable for a caller to disclose his or her location or to enable a caller to locate a called party such as when there

is no business or personal relationship between the two callers. In order that personal privacy may be protected, the present disclosure employs a protocol, system and computer program product for blocking the transfer of distance and location information so that it may be blocked from reaching a called party or the caller at the discretion of either party.

Therefore, in order that a caller and called party are both able to handshake in a series of electronic transactions designed to transmit distance and location information between them, both the caller and the called party may have an embodiment of the disclosed computer program product loaded onto their wireless and/or landline phones. A user may access an embodiment of the disclosed computer program product, also known as locID' by logging onto a website (e.g. www.mylocid.com) and registering on the site with information such as name, address and mobile telephone number, carrier, type of handset with their ESN (electronic serial number). Once a user registers his or her handset, they may choose a subscription level of options, similar to caller id features and enter a mode of payment via credit cards, bank electronic funds transfers, etc. The disclosed LocID application may therefore work with smart phones and all cell phones.

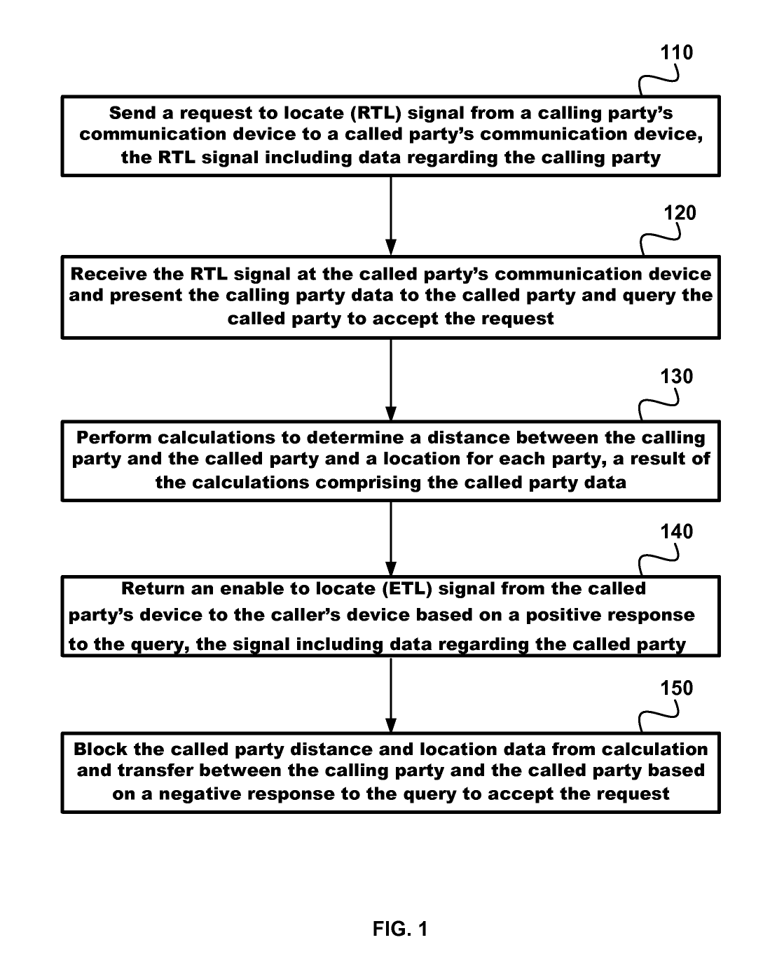

FIG. 1 is a flow chart of a method for enabling and blocking distance and location information between callers via a network in accordance with an embodiment of the present disclosure. The method includes sending 110 a request to locate (RTL) signal from a calling party's communication device to a called party's communication device, the RTL signal including data regarding the calling party. The disclosed method also includes receiving 120 the RTL signal at the called party's communication device and presenting the calling party data to the called party and querying the called party to accept the request. The method also includes performing 130 a plurality of calculations for determining a distance between the calling party and the called party and a location for each party, a result of the calculations comprising the called party data. The disclosed method may additionally include returning 140 an enable to locate (ETL) signal from the called party's device to the caller's device based on a positive response to the query, the ETL signal including data regarding the called party. Furthermore, the method includes blocking 150 the called party distance and location data from calculation and transfer via the network between the calling party and the called party based on a negative response to the query to accept the request.

An embodiment of the disclosed method includes querying the calling party to accept transferring the calling party data to the called party and blocking the transfer of the calling party's data based on a negative response to the query to transfer the calling party data to the called party. On the other hand, the method also includes transferring the calling party's data based on a positive response to the query to transfer the calling party data to the called party.

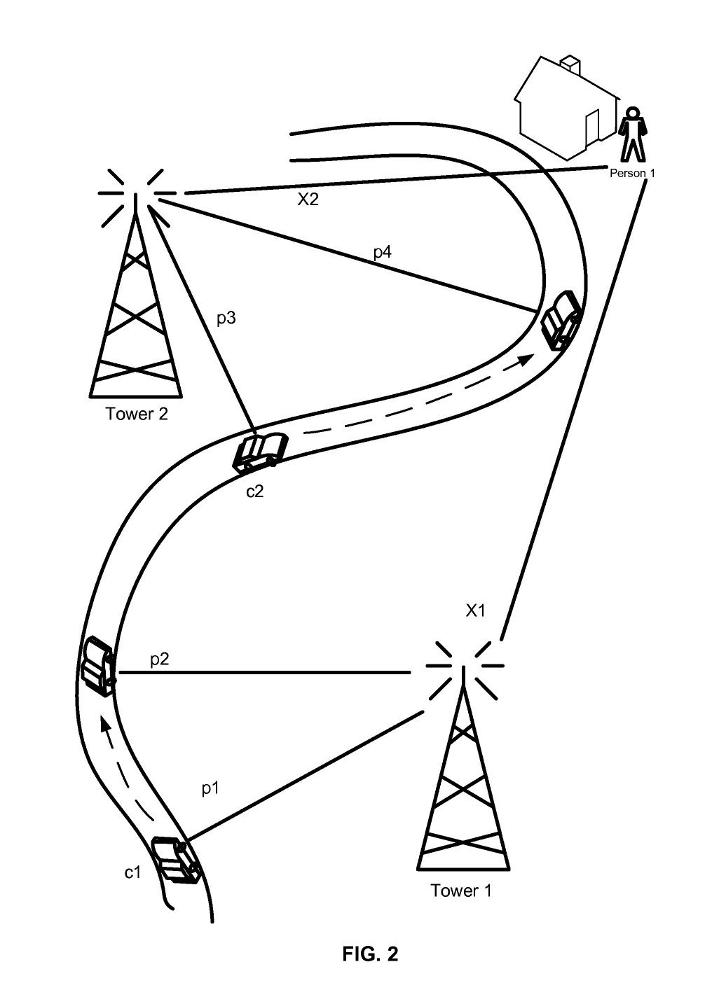

FIG. 2 depicts electronic transactions of a method for enabling and blocking distance and location information between two or more callers in accordance with an embodiment of the present disclosure. Person 1, as a caller subscribed to a ‘locID’ (location identification) service through a telecom or internet service provider, may initiate a call X1 to the driver cl which is relayed through tower 1 to the driver in transaction pl. Tower 1 transmits an RTL from the caller to the driver because tower 1 is closer to the driver than tower 2 in the depiction. The driver receives the RTL at his or her phone and a message may appear on the driver's phone alerting the driver that a caller, identified by name, phone number, and/or location (call origination point) wishes to locate the driver. An inquiry may appear on the driver's phone display such as, “Caller John Doe, phone number, locID, Do you wish to disclose your location to the caller?” If the driver does respond affirmatively, the driver's phone may send the ETL signal back to the caller through the transmission tower 1. If the driver does not wish to disclose his or her location, the driver's phone will not send the ETL signal to the caller and the caller will not be enabled to compute the distance between them or the location of the driver. However, in a business relationship, an ETL override is available which will bypass the driver's input for the ETL signal transmission to the caller's phone and automatically allow distance and/or location of the called party to be computed.

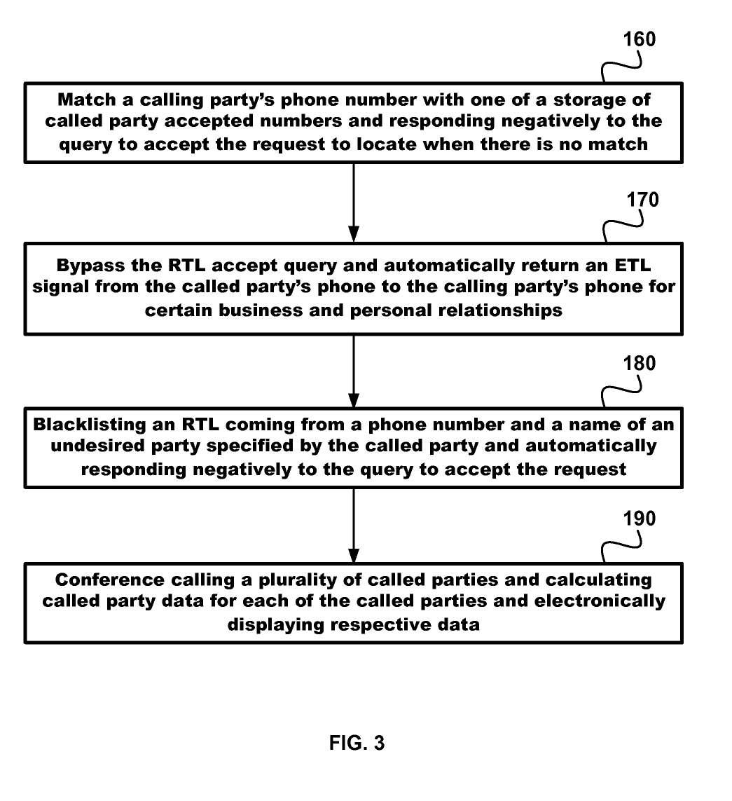

FIG. 3 is a flow chart of an embodiment of a method for enabling and blocking distance and location information between callers via a network in accordance with the present disclosure. The method includes matching 160 a calling party's phone number with a phone number from a storage of accepted called party numbers and responding negatively to the query to accept the request

to locate when there is no match (anonymous caller blocking). The method also includes bypassing 170 the RTL accept query and automatically returning an ETL signal from the called party's communication device to the calling party's communication device for certain business and personal relationships, the bypass based on one of a variable set in software and a switch set in the communications devices. The method additionally includes blacklisting 180 an RTL coming from a phone number and a name of an undesired party specified by the called party and automatically responding negatively to the query to accept the request and blocking the called party distance and location data from calculation and transfer via the network between the calling party and the called party. Furthermore, the disclosed method includes conference calling 190 multiple called parties and calculating called party data for each of the called parties and electronically displaying respective data for each of the plurality of called parties.

In an embodiment of the present disclosure, the location and distance handshaking between callers may be transacted through the internet and/or telecom landlines as well as through wireless transmissions. Therefore, a wireless caller may be able to locate a landline called party and a landline caller may be able to locate a wireless called party depending on the disclosed handshaking protocol and locID subscription privileges of the caller and the called party. In embodiments involving at least one landline caller, distances between the callers may be determined by positions of landline relays and/or internet routers relative to the landline caller. Therefore, a database of predetermined distances from each subscriber's landline connection to possible landline relays and/or internet routers may be stored in a subscription provider's database. The specific landline relays and/or internet routers used in placing a call may therefore be transmitted in the RTL handshaking protocol from one phone to another.

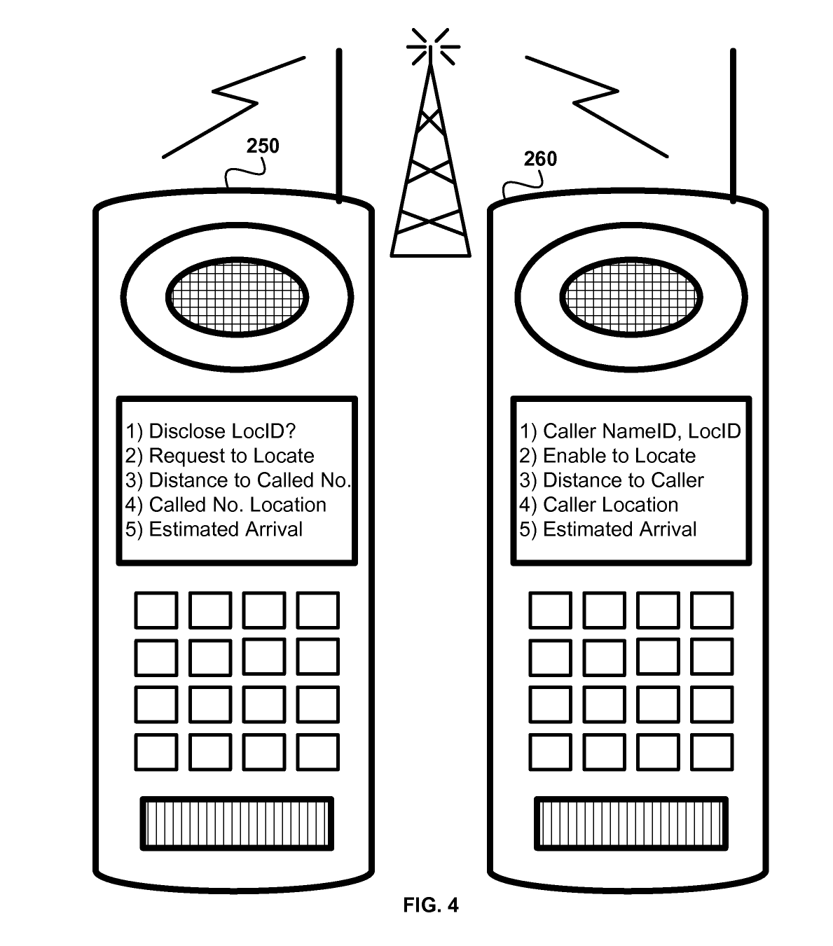

FIG. 4 depicts a wireless phone display for enabling and blocking the distance and location information between callers in accordance with an embodiment of the present disclosure. An embodiment of the present disclosure may comprise conference calls placed from a caller to multiple called parties at once though multiple receiving phones are not depicted in FIG. 2. The caller's phone 250 on the left may display one or all of the depicted options for disclosing the caller's location, options for an RTL, distance to called party (identified by phone number and/or name), called number location and estimated time of arrival based on present speed of the called party. The called party's phone 260 on the right may display the caller's name and/or location, ETL options and caller ID (identification), distance to the caller (which is equivalent to the distance to the called party displayed on the caller's phone), caller location and estimated time of arrival based on present speed of the caller. Location information may be expressed in either geographical coordinates or in standard postal zip codes. Distance may be expressed in English, metric or equivalent units at the option of the phone owner/operator.

Throughout this disclosure, the terms RTL and ETL are used as acronyms to describe the handshaking transactions between callers. Other terms less technical or even arbitrary may also be used on the displays of the caller and called party's phones to indicate similar handshaking transactions. Menus and options for managing the disclosed method and associated protocol are also included in an embodiment. For instance, after receiving the prompt, “Do you wish to disclose your location to the identified caller?” the called party may choose an option on his phone display such as “Yes, allow disclosure of my location only this one time,” or “Yes, allow disclosure of my location for all requests,” or “No, do not allow disclosure of my location to this caller at this time.” The phone and display design are merely representative of phones that may be used by the caller and the called party. Phones and displays of various makes and models are included in embodiments of the disclosure.

Returning to FIG. 2, the time for an RTL signal from Person 1 to reach tower 1 and tower 2 may be used to triangulate the location of Person 1 relative to the two stationary tower transmitters. For example, the time it took pl to be received at tower 1 may determine a radial distance from tower 1. The time it took p1 to be received at tower 2 may determine a radial distance from tower 2. Where the distance between the two towers is known, the intersection of the two radii therefore may triangulate the location of Person 1.

Likewise, the time for the driver's signals to reach towers 1 and 2 may be used to triangulate the location and distance of the driver from towers 1 and 2. Hence, the sum of the distance from the driver to either tower and the distance from either tower to Person 1 may equal the distance between the driver and the caller.

Additionally, a second transmission p2 from the driver's phone may be sent in order for the driver's speed to be calculated. Therefore, the computer program product of the present system and method may ping the location of the driver a time period t2 from when the caller placed a call to the driver. The time it takes for a response from the driver's phone to tower 1 and back to the caller may then be used to triangulate the updated location of the driver and hence his or her approximate speed on a given route.

Similarly, the location and distance of a second driver c2 from Person 1 may be determined from triangulation between towers 1 and 2 and driver 2 in a second transmission X2. Embodiments of the disclosed method and system may therefore compute and track multiple called parties including utilizing phone memory for storing the location and/or distance of a called party at multiple time points. The disclosed method and system may also include a means for downloading location and distance data to a computer device for further processing and documentation. Disclosed embodiments may also include backend processes for matching a driver's route with needed furniture deliveries. The backend processes may alert the caller to potential new route matches in the driver's original route.

Distance between callers may be likewise calculated from GPS trilateration data. Trilateration data may predetermine the location of the caller and the called party so that the disclosed system may calculate the distance between the calling parties. Subsequent location data may also allow the disclosed system to calculate an estimated arrival of the driver at any point along the driver's route. The furniture store owner or manager in the foregoing example may therefore apprise customers of a precise arrival time for their furniture simply by placing a call to his delivery crew without even having to speak with them.

The disclosed method also provides for blocking all RTL from numbers and names of people chosen by the caller for ‘blacklisting.’ A blacklisted name and/or number may be automatically blocked from appearing on the called party's phone display as an RTL. This way the called party's location is never broadcast to the caller or to any other interloper and maintains the privacy of the called party at his or her option. A called party may remove a blacklisted caller at any time. Also, anonymous caller blocking is part of an embodiment of the present disclosure. Anonymous caller blocking, at the option of the called party, will automatically block all RTL without having to query the called party to respond. Anonymous caller blocking may be set for a given time period and then require a refresh action by the called party to remain active or it may be set indefinitely with a pass code to deactivate.

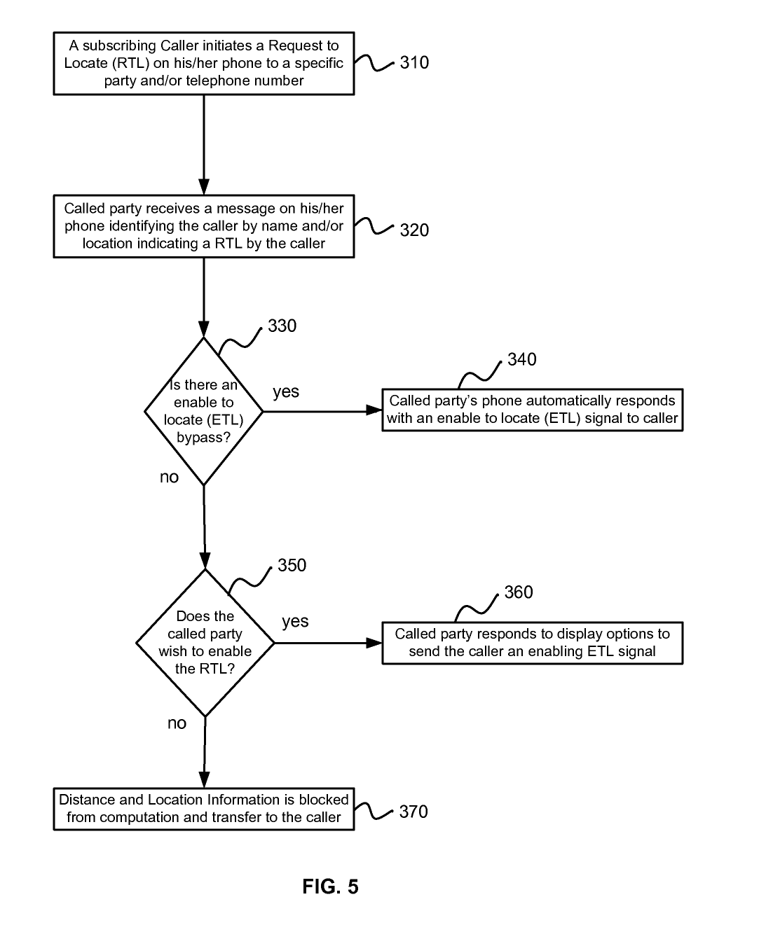

FIG. 5 depicts a flow chart of a method for distance and location identification between two callers in accordance with an embodiment of the present disclosure. The method includes a subscribing caller initiating 310 an RTL on his/her phone to a specific party and telephone number. The method also includes the called party receiving 320 a message on his or her phone identifying the caller by name and/or location indicating an RTL by the caller. Also, determining 330 whether there is an ETL override is a logical part of the disclosed method that may be automated and transparent to the called party. The caller may be required to enter an ETL override code in order for the ETL override to become activated. The ETL override may trigger the called party's phone to automatically respond 340 with an ETL signal to the caller. In the absence of an ETL override, logic is disclosed for determining 350 whether the called party wishes to enable the caller's RTL. If the called party wishes to enable the caller's RTL, the called party responds 360 to his or her phone display options to send the caller an enabling ETL signal. If the called party does not wish to enable the caller's RTL, distance and location information is blocked 370 from computation and transfer to the caller.

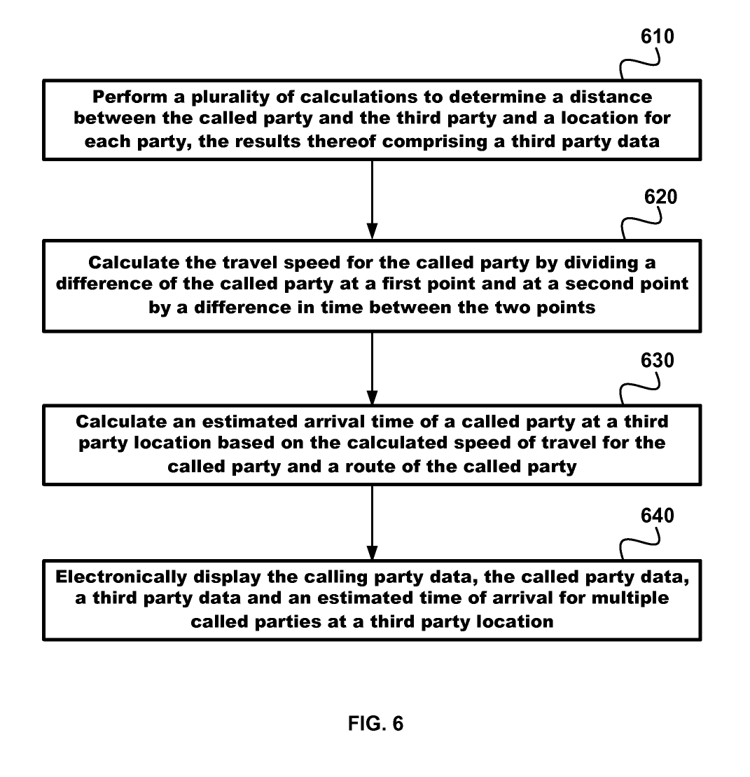

FIG. 6 is a flow chart of a method for calculating an estimated time of arrival of a called party at a third party location in accordance with an embodiment of the present disclosure. The method includes performing 610 a plurality of calculations for determining a distance between the called party and the third party and a location for each party, a result of the calculations comprising a third party data. The method also includes calculating 620 a travel speed for a called party by dividing a difference in position of the called party at a first point and at a second point by a difference in time between the two points. The method additionally includes calculating 630 an estimated arrival time of a called party at

a third party location based on the calculated speed of travel for the called party and a route of the called party to the third party. Furthermore, the disclosed method includes displaying electronically 640 the calling party data, the called party data, a third party data and an estimated time of arrival for at least one of a plurality of called parties at a third party location, the displaying performed on an electronic display device.

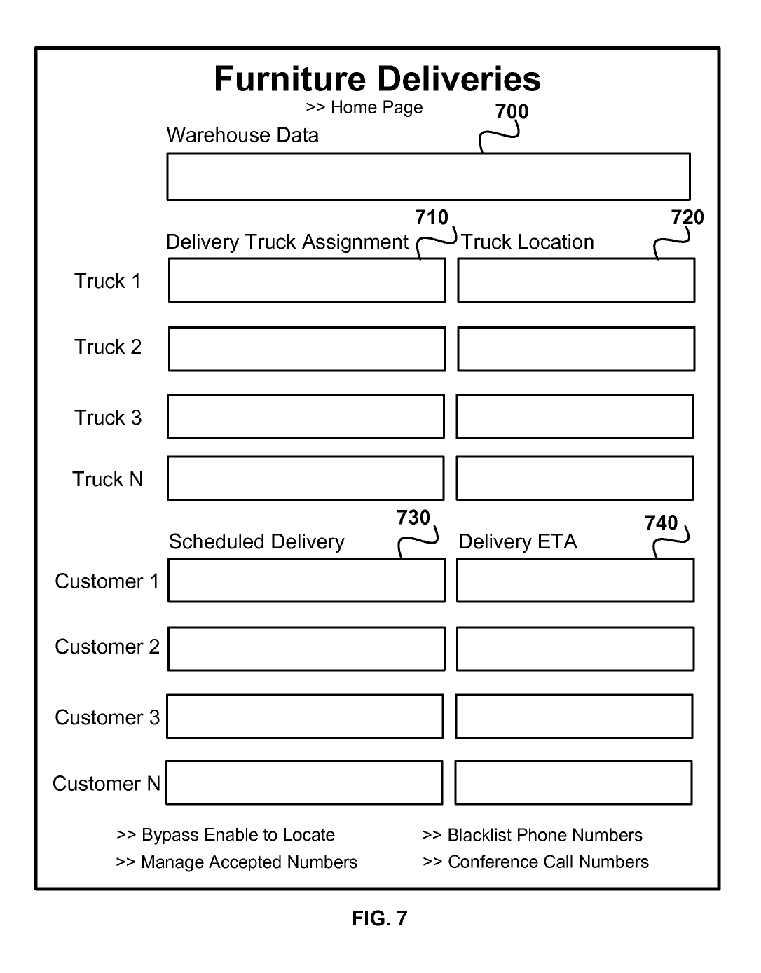

FIG. 7 is a depiction of an electronic display of called parties and third parties in relation to estimated time of arrival of furniture deliveries in accordance with an embodiment of the present disclosure. The embodiment is thus one machine transformation of the disclosed method and computer program product and protocol. The display includes warehouse data 700, delivery truck assignment(s) 710, truck location 720, scheduled delivery times 730 and delivery estimated time of arrival 740. The display also includes links to other webpages in the website such as links for a home page, a bypass enable to locate page, a manage accepted numbers page, a blacklist phone numbers page and a conference call phone numbers webpage. The warehouse 700, also known as the home base or office, may comprise the calling party in the disclosed method and protocol. The delivery truck assignment 710 may comprise a client's name and/or address for trucks 1, 2 and 3 and up to any arbitrary N number of trucks or delivery vehicles employed directly or on a subcontract basis with the warehouse or furniture company of interest. The truck location 720 may be expressed in terms of geographical coordinates or in terms of other indicators such as street names and postal codes. Each truck is therefore a called party in the disclosure. The truck location is transferred to the warehouse or office as part of the ETL transfer or in a separate and subsequent transmission. The scheduled delivery 730 my comprise a customer's name and/or address for customers 1, 2 and 3 and up to any arbitrary N number of customers or clients. The customers or clients are thus third parties in the disclosure. The delivery ETA 740 (estimated time of arrival) may be expressed as a date and time based on a calculated travel speed for a truck per the present disclosure a route the truck is expected to take. The route a particular truck may take may be specified by electronic and electromagnetic mapping methods and algorithms also known as GPS (global positioning satellite) navigation to persons of ordinary skill in the art. The disclosure apprises a delivery manager of the timeliness of his fleet and therefore enables him to make changes to delivery assignments where needed to maintain schedule. The disclosure may therefore help a business manager/owner to efficiently run his business and increase customer satisfaction for on-time deliveries and therefore increase profitability.

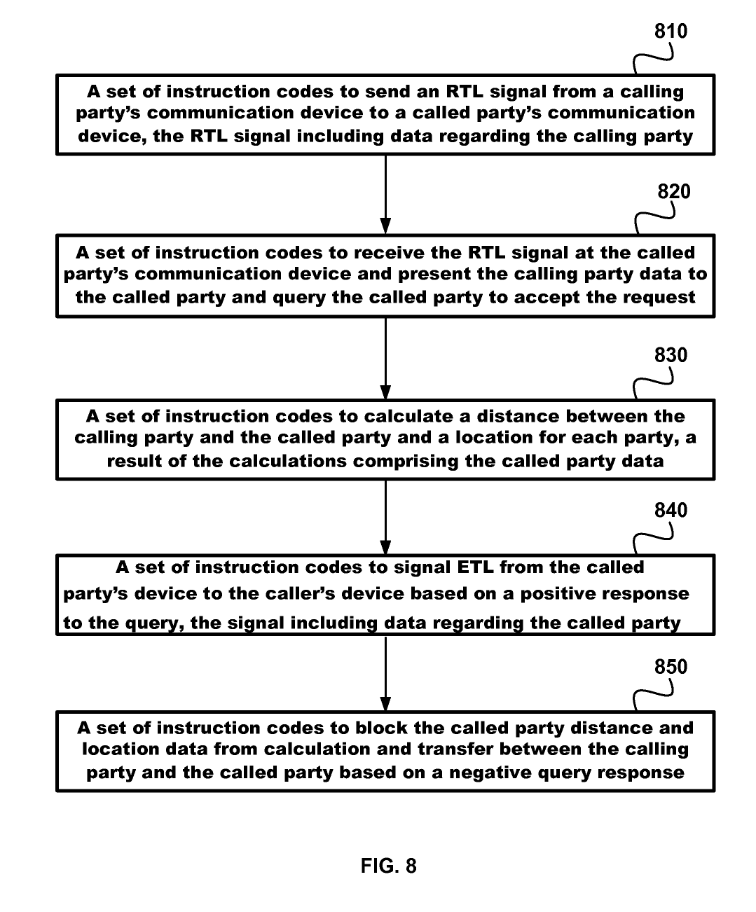

FIG. 8 is a flow chart of a computer program product for enabling and blocking distance and location information between callers in accordance with an embodiment of the present disclosure. The computer program product includes a set of instruction codes for sending 810 a request to locate (RTL) signal from a calling party's communication device to a called party's communication device, the RTL signal including data regarding the calling party. The computer program product also includes a set of instruction codes for receiving 820 the RTL signal at the called party's communication device and presenting the calling party data to the called party and querying the called party to accept the request. The computer program product additionally includes a set of instruction codes for performing 830 a plurality of calculations for determining a distance between the calling party and the called party and a location for each party, a result of the calculations comprising the called party data. The computer program product further includes a set of instruction codes for returning 840 an enable to locate (ETL) signal from the called party's device to the calling party's device based on a positive response to the query, the ETL signal including data regarding the called party. Further yet, the computer program product includes a set of instruction codes for blocking 850 the called party distance and location data from calculation and transfer via the network between the calling party and the called party based on a negative response to the query to accept the request.

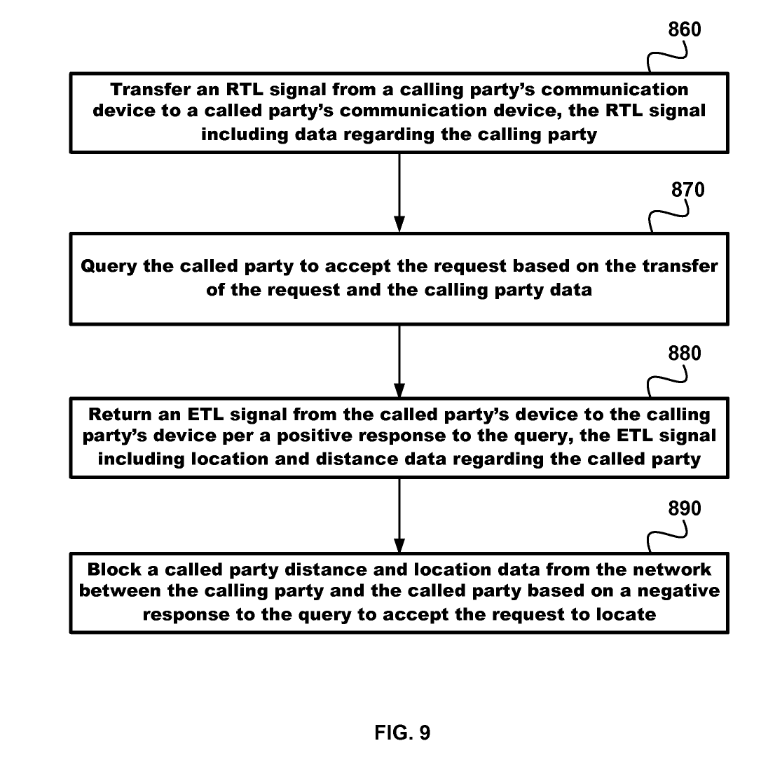

FIG. 9 is a flow chart of a communications protocol for blocking distance and location information between callers in accordance with an embodiment of the present disclosure. The protocol includes transferring 960 a request to locate (RTL) signal from a calling party's communication device to a called party's communication device, the RTL signal including data regarding the calling party. The protocol also includes querying 970 the called party to accept the request based on the transfer of the request and the calling party data. The protocol additionally includes returning 980 an enable to locate (ETL) signal from the called party's device to the calling party's device based on a positive response to the query, the ETL signal including location and distance data regarding the called party. The disclosed protocol further includes blocking 990 a called party distance and location data from transfer via the network between the calling party and the called party based on a negative response to the query to accept the request to locate.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A method for managing location information between callers via a network, comprising:
sending a request to locate (RTL) signal from a calling party's communication device to a called party's communication device, the RTL signal including data regarding the calling party;
receiving the RTL signal at the called party's communication device and presenting the calling party data to the called party and querying the called party to accept the request;
performing a plurality of calculations for determining a distance between the calling party and the called party and a location for each party, a result of the calculations comprising the called party data;
returning an enable to locate (ETL) signal from the called party's device to the caller's device based on a positive response to the query, the ETL signal including data regarding the called party; and
blocking the called party distance and location data from calculation and transfer via the network between the calling party and the called party based on a negative response to the query to accept the request.

2. The method for managing location information between callers of claim 1, wherein the network comprises one of a voice, a data, an internet, a wireless and a satellite technology and any combination thereof.

3. The method for managing location information between callers of claim 1, wherein a communication device comprises any electronic electromagnetic communications device including a landline telephone, a cellular telephone, a voice-over-internet-protocol phone, a texting device, a computer, a personal digital assistant, a walkie-talkie, a satellite phone, a smart wrist-watch and the like.

4. The method for managing location information between callers of claim 1, wherein the calling party data includes at least one of a calling party's name and a calling party's location based on whether the calling party is subscribed to a location identification service and the calling party does not block a disclosure of his or her location.

5. The method for managing location information between callers of claim 1, wherein the called party data includes at least one of a called party's name and a called party's location based on whether the called party is subscribed to a location identification service and the called party does not block a disclosure of his or her location.

6. The method for managing location information between callers of claim 1, wherein performing a plurality of calculations for determining a distance between the calling party and the called party and a location for each party further comprises triangulating the location and distance from the calling party to a called party using a transmission time between the callers and multiple stationary wireless transmitters, landline relays and internet routers.

7. The method for managing location information between callers of claim 1, wherein performing a plurality of calculations for determining a distance between the calling party and the called party and a location for each party further comprises trilaterating data from GPS satellites to determine the distance between the caller and the called party given location information for the calling party and the called party.

8. The method for managing location information between callers of claim 1, wherein performing a plurality of calculations for determining a distance between the calling party and the called party and a location for each party further comprises:
transmitting one of at least one landline relay and at least one internet router used in placing a call from one party to another party; and
determining a distance from a party's landline connection to a plurality of landline relays and internet routers enroute to the other party.

9. The method for managing location information between callers of claim 1, wherein blocking the called party distance and location data further comprises matching a calling party's communication number with one of a storage of called party accepted numbers and responding negatively to the query to accept the request to locate when there is no match.

10. The method for managing location information between callers of claim 1, wherein location information may be expressed in at least one of geographical coordinate and in a postal zip code.

11. The method for managing location information between callers of claim 1, further comprising performing a plurality of calculations for determining a distance between the called party and the third party and a location for each party, a result of the calculations comprising a third party data.

12. The method for managing location information between callers of claim 1, further comprising:
querying the calling party to accept transferring the calling party data to the called party;
blocking the transfer of the calling party's data based on a negative response to the query to transfer the calling party data to the called party; and
transferring the calling party's data based on a positive response to the query to transfer the calling party data to the called party.

13. The method for managing location information between callers of claim 1, further comprising bypassing the RTL accept query and automatically returning an ETL signal from the called party's communication device to the calling party's communication device for certain business and personal relationships, the bypass based on one of a variable set in software and a switch set in the communications devices.

14. The method for managing location information between callers of claim 1, further comprising blacklisting an RTL coming from a phone number and a name of an undesired party specified by the called party and automatically responding negatively to the query to accept the request and blocking the called party distance and location data from calculation and transfer via the network between the calling party and the called party.

15. The method for managing location information between callers of claim 1, further comprising conference calling a plurality of called parties and calculating called party data for each of the called parties and electronically displaying respective data for each of the plurality of called parties.

16. The method for managing location information between callers of claim 1, further comprising calculating a travel speed for a called party by dividing a difference in position of the called party at a first point and at a second point by a difference in time between the two points.

17. The method for managing location information between callers of claim 14, further comprising calculating an estimated arrival time of a called party at a third party location based on the calculated speed of travel for the called party and a route of the called party to the third party.

18. A computer program product comprising a computer readable medium having computer useable instruction codes executable to perform operations for managing location information between callers via a network, the operations of the computer program product comprising:
a set of instruction codes for sending a request to locate (RTL) signal from a calling party's communication device to a called party's communication device, the RTL signal including data regarding the calling party;
a set of instruction codes for receiving the RTL signal at the called party's communication device and presenting the calling party data to the called party and querying the called party to accept the request;
a set of instruction codes for performing a plurality of calculations for determining a distance between the calling party and the called party and a location for each party, a result of the calculations comprising the called party data;
a set of instruction codes for returning an enable to locate (ETL) signal from the called party's device to the calling party's device based on a positive response to the query, the ETL signal including data regarding the called party; and
a set of instruction codes for blocking the called party distance and location data from calculation and transfer via the network between the calling party and the called party based on a negative response to the query to accept the request.

19. The computer program product of claim 18, further comprising displaying the calling party data, the called party data, a third party data and an estimated time of arrival for at least one of a plurality of called parties at a third party location, the displaying performed on an electronic display device.

20. A protocol for managing location information between callers via a network, comprising:
transferring a request to locate (RTL) signal from a calling party's communication device to a called party's communication device, the RTL signal including data regarding the calling party;
querying the called party to accept the request to locate based on the transfer of the request and the calling party data;
returning an enable to locate (ETL) signal from the called party's device to the calling party's device based on a positive response to the query, the ETL signal including location and distance data regarding the called party; and
blocking a called party distance and location data from transfer via the network between the called party and the calling party based on a negative response to the query to accept the request to locate.
